(19) United States
(12) Patent Application Publication
(10) Pub. No.: US 2010/0318276 A1
(43) Pub. Date: Dec. 16, 2010

(54) Control Strategy For A Diesel Engine During Lean-Rich Modulation

(76) Inventors: Zhengbai Liu, Naperville, IL (US); Puning Wei, Naperville, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(21) Appl. No.: 12/481,661

(22) Filed: Jun. 10, 2009

(51) Int. Cl. F02D 41/30

(52) U.S. Cl. 701/103

(57) ABSTRACT

The control system controls lean-rich modulation of fueling using a set of engine specific fueling parameter maps. One set of maps is a set of lean fueling maps, and another set is a set of rich fueling maps. The two map sets each comprise a fuel injection pressure map, an EGR valve opening map, and a VGT valve opening map, established for the particular diesel engine, with neither form of modulation requiring post injection. The strategy is represented by a flow diagram and is useful in regenerating an NOx adsorber catalyst in the engine exhaust system in a manner that controls torque so that the regeneration process is transparent to the operator of the vehicle, while producing significant fuel savings.

### BACKGROUND OF THE INVENTION

1. Field of the Invention

The present invention relates to control strategy for regeneration of an NOx adsorber of a diesel engine. The control strategy for such regeneration is engine specific, requires no post injection for either lean modulation or rich modulation, and controls engine torque so that the regeneration process is transparent to the operator of the vehicle, while producing significant fuel savings.

2. Prior Art

An NOx adsorber will always be necessary for use with diesel engines to meet the requirements of increasingly stringent EPA emissions regulations. To assure that such NOx adsorber works well, it is necessary to regenerate it periodically.

The diesel engine with the NOx adsorber necessarily works under two types of conditions, that is, at lean modulation wherein the diesel engine works at normal status, and at rich modulation wherein the diesel engine works at a status of regenerating the NOx adsorber.

During regeneration, the NOx adsorber requires a high percentage of CO (carbon oxide) and HC (hydrocarbon) in the exhaust gas output of the engine.

Presently, a post fuel injection method is utilized for NOx adsorber regeneration, such as that disclosed in U.S. Pat. No. 6,990,951. Such post injection method has two disadvantages. One is that it increases fuel consumption, and the other is that it leads to a fluctuation in torque during lean-rich modulation conversion, which problem must be solved by using the control strategy disclosed in U.S. Pat. No. 6,990,951 or by another suitable method.

Accordingly there is a need for an improved control strategy for NOx adsorber regeneration.

### SUMMARY OF THE INVENTION

According to the invention there is provided an engine specific control strategy for NOx adsorber regeneration in an ECU controlled diesel engine comprising the steps of: determining whether the engine is running under rich modulation control or lean modulation control, and adjusting the fuel injection pressure, the EGR (exhaust gas recirculation) valve open percentage, the VGT (variable geometry turbo) valve open percentage, as determined from a corresponding set of three maps stored in ECU memory, one set corresponding to rich modulation control, and the other set corresponding to lean modulation control, to maintain engine torque constant without compromising emissions or BSFC (brake specific fuel consumption), and without post-injection during either modulation control.

### BRIEF DESCRIPTION OF THE DRAWINGS

FIG. 1 shows a schematic diagram of a diesel engine system in which the present invention may be used.

FIG. 2 provides a logic flow diagram of the engine specific control strategy for lean-rich modulation, without post-injection, according to the present invention.

### DESCRIPTION OF THE PREFERRED EMBODIMENT

During empirical testing, it was found that when fuel injection timing is advanced, the percentage of both HC and CO in the exhaust gas increases dramatically.

At the same time, if fuel injection pressure is adjusted, via adjustment of the EGR (exhaust gas recirculation) valve open percentage, and the VGT (variable geometry turbo) valve open percentage, the engine torque can be maintained constant without compromising emissions or BSFC (brake specific fuel consumption).

Based on the above discovery, an NOx adsorber regeneration control strategy for a diesel engine during lean-rich modulation is provided without the drawbacks of the post fuel injection method discussed above.

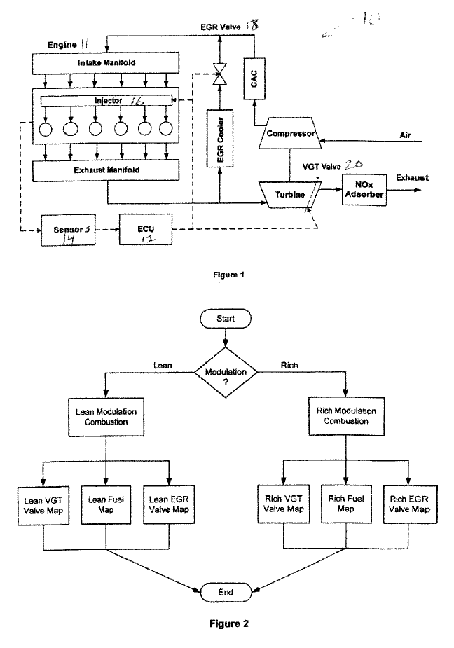

Referring now to the drawings in greater detail, FIG. 1 shows a schematic diagram of an exemplary diesel engine system, generally identified by reference numeral 10, in which the present control strategy may be used.

The exemplary engine system 10 operates in two combustion modes, one lean and one rich. A set of maps is created for the specific engine 11 for each combustion mode with relation to fuel injection pressure, EGR valve opening and VGT valve opening wherein the correlated maps of the above parameters, of a set, provide for engine control to produce constant engine torque when selected. The engine specific lean fuel injection pressure map, the lean VGT valve map, and the lean EGR valve map are all empirically preestablished through operation of the particular diesel engine at its lean modulation.

The engine specific rich fuel injection pressure map, the rich VGT valve map, and the rich EGR valve map are all empirically preestablished through operation of the particular diesel engine at its rich modulation.

The lean fuel injection pressure map includes at least one fuel injection, but may have multiple fuel injections, without post injection.

The rich fuel injection map includes at least one fuel injection, but may have multiple fuel injections, without post injection.

The engine ECU 12 (electronic control unit) stores the two empirically predetermined sets of fuel injection pressure maps, EGR valve opening maps, and VGT valve opening maps, established for the particular diesel engine, and receives engine operating data from corresponding sensors 14. After processing sensor input, executive commands are sent to the fuel injectors 16, the EGR valve 18, and the VGT valve 20, based on selection of the appropriate set of stored maps to maintain engine torque constant during the particular type of combustion mode taking place.

FIG. 2 provides a logic flow diagram of the control strategy for the lean-rich modulation control strategy of the present invention.

At the first step, the engine control unit 12 begins to receive sensor input signals, and from the input signals determines the instantaneous operating (combustion) mode of the particular diesel engine to which the control strategy is specific.

If lean modulation is determined to be taking place, the control process moves on to the lean modulation combustion mode, and the lean fuel injection pressure map, the lean VGT valve map, and the lean EGR valve map are simultaneously selected to execute engine control, until the lean modulation combustion cycle ends.

If the rich modulation is determined to be taking place, the control process moves on to the rich modulation combustion mode, and the rich fuel injection pressure map, the rich VGT valve map, and the rich EGR valve map are simultaneously selected to execute engine control, until the rich modulation combustion cycle ends. During this rich modulation combustion cycle, NOx adsorber regeneration is accomplished, as described above.

In summary, the NOx adsorber regeneration control strategy of the present invention has the following unique features.

The control strategy realizes the lean-rich modulation combustion in a diesel engine without compromising emissions.

The control strategy provides enough percentage of CO and HC to regenerate the NOx adsorber at the rich modulation.

The control strategy maintains the diesel engine torque constant at the lean-rich modulation.

The control strategy significantly reduces fuel consumption by avoiding post injection during either type of modulation.

The control strategy makes the diesel engine work at optimized conditions for both lean modulation and rich modulation.

The engine specific control strategy may be used for controlling heavy-duty and medium-duty, as well as light-duty diesel engines.

As described above, the control strategy of the present invention provides a number of advantages, some of which have been described above, and others of which are inherent in the invention. It will be understood that modifications may be proposed to the strategy without departing from the teachings herein. Accordingly, the scope of the invention is only to be limited as necessitated by the accompanying claims.

1. A method of operating a compression ignition engine to accomplish lean-rich modulation of fueling, the method comprising: processing certain engine specific data to modulate fueling between lean modulation and rich modulation; during lean modulation, processing data representing a particular set of operating conditions to select a particular set of lean modulation maps that comprise data appropriate to the particular set of operating conditions for causing the engine to be fueled in a manner that causes the engine to run lean and develop a corresponding torque; and during rich modulation, processing data representing substantially the same particular set of operating conditions to select a particular set of rich modulation maps that comprises data appropriate to that substantially same particular set of operating conditions for causing the engine to be fueled in a manner that causes the engine to run rich and develop substantially the same corresponding torque as during lean modulation.

2. The method as set forth in claim 1 wherein during either rich or lean modulation, the particular set of corresponding modulation maps selected cause the engine to be fueled by at least a main fuel injection without post-injection.

3. The method as set forth in claim 1 wherein each set of modulation maps comprises three maps.

4. The method as set forth in claim 1 wherein a first map of the three maps details fuel injection pressure.

5. The method as set forth in claim 1 wherein a second map of the three maps details exhaust gas recirculation valve opening percentage.

6. The method as set forth in claim 1 wherein a third map of the three maps details variable geometry turbo valve open percentage.

7. A compression ignition engine comprising: an engine specific control system for processing data including a set of lean fueling maps and a set of rich fueling maps; one or more combustion chambers; and a fueling system for injecting fuel into the one or more combustion chambers; wherein the control system at times modulates fueling between lean modulation and rich modulation, and for lean modulation, processes data representing a particular set of operating conditions to select a particular set of lean fueling maps that comprise fueling data appropriate to the particular set of operating conditions for causing the engine to be fueled in a manner that causes the engine to run lean and develop a corresponding torque; and for rich modulation, processes data representing substantially the same particular set of operating conditions to select a particular set of rich fueling maps that comprise fueling data appropriate to that substantially same particular set of operating conditions for causing the engine to be fueled in a manner that causes the engine to run rich and develop substantially the same corresponding torque as during lean modulation, both rich and lean modulation causing the engine to be fueled by at least a main fuel injection without post-injection.

8. The method as set forth in claim 7 wherein each set of modulation maps comprises three maps.

9. The method as set forth in claim 8 wherein a first map of the three maps details fuel injection pressure.

10. The method as set forth in claim 8 wherein a second map of the three maps details exhaust gas recirculation valve opening percentage.

11. The method as set forth in claim 8 wherein a third map of the three maps details variable geometry turbo valve open percentage.

12. A method of operating a specific compression ignition engine to accomplish lean-rich modulation of fueling for regeneration of a NOx adsorber catalyst in an exhaust system of the engine, the method comprising: processing certain engine specific data to modulate fueling between lean modulation and rich modulation; during lean modulation, processing data representing a particular set of operating conditions to select a particular set of lean fueling maps that comprise fueling data appropriate to the particular set of operating conditions for causing the engine to be fueled in a manner that causes the engine to run lean and develop a corresponding torque; and during rich modulation, processing data representing substantially the same particular set of operating conditions to select a particular set of rich fueling maps that comprise fueling data appropriate to that substantially same particular set of operating conditions for causing the engine to be fueled in a manner that causes the engine to run sufficiently rich to create sufficient carbon monoxide for regenerating the NOx adsorber catalyst while developing substantially the same corresponding torque as during lean modulation.

13. A method as set forth in claim 12 wherein during lean modulation, the particular set of lean fueling maps selected causes the engine to be fueled by a main fuel injection without post-injection.

14. A method as set forth in claim 12 wherein during lean modulation, the particular set of lean fueling maps selected causes the engine to be fueled by one or more pilot injections followed by a main fuel injection without post-injection.

15. A method as set forth in claim 12 wherein during rich modulation, the particular set of rich fueling maps selected causes the engine to be fueled by a main fuel injection without post-injection.

16. A method as set forth in claim 12 wherein during rich modulation, the particular set of rich fueling maps selected causes the engine to be fueled by one or more pilot injections followed by a main fuel injection without post-injection.

17. A compression ignition engine comprising: a control system for processing engine specific data including a set of lean fueling maps and a set of rich fueling maps; one or more combustion chambers; a fueling system for injecting fuel into the one or more combustion chambers; and an exhaust system having a NOx adsorber catalyst through which exhaust from the combustion chambers is constrained to pass; wherein the control system at times modulates fueling between lean modulation and rich modulation for regenerating the NOx adsorber catalyst, and for lean modulation, processes data representing a particular set of operating conditions to select a particular set of lean fueling maps that comprise fueling data appropriate to the particular set of operating conditions for causing the engine to be fueled in a manner that causes the engine to run lean and develop a corresponding torque; and for rich modulation, processes data representing substantially the same particular set of operating conditions to select a particular set of rich fueling maps that comprise fueling data appropriate to that substantially same particular set of operating conditions for causing the engine to be fueled in a manner that causes the engine to run sufficiently rich to create sufficient carbon monoxide for regenerating the NOx adsorber catalyst while developing substantially the same corresponding torque as during lean modulation.

18. An engine as set forth in claim 17 wherein for lean modulation, the control system selects a particular set of lean fueling maps that causes the engine to be fueled by a main fuel injection without post-injection.

19. An engine as set forth in claim 17 wherein for lean modulation, the control system selects a particular set of lean fueling maps that causes the engine to be fueled by one or more pilot injections followed by a main fuel injection without post-injection.

20. An engine as set forth in claim 17 wherein for rich modulation, the control system selects a particular set of rich fueling maps that causes the engine to be fueled by a main fuel injection without post-injection.

21. An engine as set forth in claim 17 wherein for rich modulation, the control system selects a particular set of rich fueling maps that causes the engine to be fueled by one or more pilot injections followed by a main fuel injection without post-injection.
